(19) United States
(12) Patent Application Publication
(10) Pub. No.: US 2020/0090232 A1
(43) Pub. Date: Mar. 19, 2020

(54) SYSTEMS AND METHODS FOR VEHICLE VALUE EVALUATION

(71) Applicant: BEIJING DIDI INFINITY TECHNOLOGY AND DEVELOPMENT CO., LTD., Beijing (CN)

(72) Inventors: Duokun ZHANG, Beijing (CN); Min LI, Beijing (CN); Yu WANG, Beijing (CN); Rui GUO, Beijing (CN); Hongfeng WANG, Beijing (CN)

(73) Assignee: BEIJING DIDI INFINITY TECHNOLOGY AND DEVELOPMENT CO., LTD., Beijing (CN)

(21) Appl. No.: 16/690,341

(22) Filed: Nov. 21, 2019

Related U.S. Application Data
(63) Continuation of application No. PCT/CN2017/089539, filed on Jun. 22, 2017.

(51) Int. Cl. G06Q 30/02; G07C 5/00

(52) U.S. Cl. CPC G06Q 30/0278; G07C 5/008; G06Q 30/0281

(57) ABSTRACT

The present disclosure relates to systems and methods for vehicle value evaluation. The systems may perform the methods to identify a mobile terminal; obtain target information associated with the mobile terminal and a target vehicle associated with the mobile terminal; determine a current estimated value of the target vehicle based on the target information; and send the current estimated value of the target vehicle to the mobile terminal.

### CROSS-REFERENCE TO RELATED APPLICATIONS

This application is a continuation of International Application No. PCT/CN2017/089539, filed on Jun. 22, 2017, the content of which is incorporated herein by reference to its entirety.

### TECHNICAL FIELD

The present disclosure generally relates to vehicle management, and more specifically, relates to systems and methods for vehicle value evaluation.

### BACKGROUND

In existing systems and methods for vehicle value evaluation, a vehicle's market value may be evaluated when a user (e.g., an owner of the vehicle or a driver of the vehicle) sends a request to the existing systems. In addition, the existing systems may evaluate the vehicle's market value based on historical information (e.g., a historical mileage) of the vehicle rather than real-time information (e.g., a real-time mileage) of the vehicle. It is desirable to provide systems and methods for vehicle value evaluation to automatically evaluate a value of a vehicle based on real-time information of the vehicle.

### SUMMARY

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

An electronic system may include one or more storage media comprising a set of instructions for determining a vehicle value; and one or more processors configured to communicate with the one or more storage media. When executing the set of instructions, the one or more processors are directed to: identify a mobile terminal; obtain target information associated with the mobile terminal and a target vehicle associated with the mobile terminal; determine a current estimated value of the target vehicle based on the target information; and send the current estimated value of the target vehicle to the mobile terminal.

A method for determining a vehicle value may include identifying, by at least one computer server, a mobile terminal; obtaining, by the at least one computer server, target information associated with the mobile terminal and a target vehicle associated with the mobile terminal; determining, by the at least one computer server, a current estimated value of the target vehicle based on the target information; and sending, by the at least one computer server, the current estimated value of the target vehicle to the mobile terminal.

A non-transitory processor-readable storage medium, comprising a set of instructions for determining value of a vehicle, wherein when executed by at least one processor, the set of instruction directs the at least one processor to perform acts of: identifying a mobile terminal; obtaining target information associated with the mobile terminal and a target vehicle associated with the mobile terminal; determining a current estimated value of the target vehicle based on the target information; and sending the current estimated value of the target vehicle to the mobile terminal.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary vehicle value evaluation system according to some embodiments of the present disclosure;

FIG. 2 is a schematic diagram illustrating exemplary hardware and/or software components of an exemplary computing device on which a processing engine may be implemented according to some embodiments of the present disclosure;

FIG. 3 is a schematic diagram illustrating exemplary hardware and/or software components of an exemplary mobile device on which one or more terminals may be implemented according to some embodiments of the present disclosure;

FIG. 4 is a schematic block diagram illustrating an exemplary processing engine according to some embodiments of the present disclosure; and

FIG. 5 is a flowchart illustrating an exemplary process for determining a current estimated value of a target vehicle according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily regarding evaluating a value of a vehicle, it should also be understood that this is only one exemplary embodiment. The vehicle may include a horse, a carriage, a rickshaw (e.g., a wheelbarrow, a bike, a tricycle, etc.), an electromobile (e.g., an electric bike, an electric tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof. The application of the system or method of the present disclosure may include a web page, a plug-in of a browser, a client terminal, a custom system, an internal analysis system, an artificial intelligence robot, or the like, or any combination thereof.

An aspect of the present disclosure relates to online systems and methods for evaluate a vehicle. The system may target information of a target vehicle through a mobile phone of a driver of the target vehicle, and then provide evaluation of the target vehicle. For example, by tracking the mobile phone, the system may obtain mileage or accident information of the vehicle and at the right time, provide evaluation of the target vehicle via the mileage and accident information of the vehicle without receiving a request from the user of the mobile phone.

Since the systems and methods in the present disclosure includes novel technical solutions of obtaining important information of a vehicle in real-time through internet. The technical solutions will not be possible without Internet technology. Therefore, the technical solutions are deeply rooted in Internet technology and solve a problem of real-time vehicle evaluation that can only raise in post-Internet era. In pre-Internet era, a value of a vehicle may be evaluated by a professional based on his/her experience in vehicle value evaluation. The online vehicle value evaluation system, however, may obtain information associated with the vehicle via the Internet, and automatically determine the value of the vehicle based on the information associated with the vehicle and one or more machine learning models. Therefore, through the Internet, the online vehicle value evaluation systems may provide a much more efficient platform for users that may never meet in a traditional pre-Internet era.

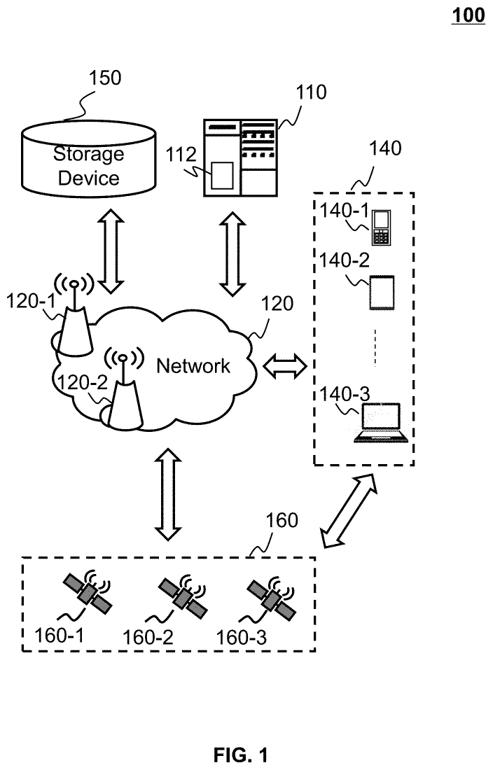

FIG. 1 is a schematic diagram of an exemplary vehicle value evaluation system 100 according to some embodiments. The vehicle value evaluation system 100 may include at least one server 110, at least one network 120, at least one mobile terminal 140, at least one storage device 150, and at least one positioning system 160. The server 110 may include a processing engine 112.

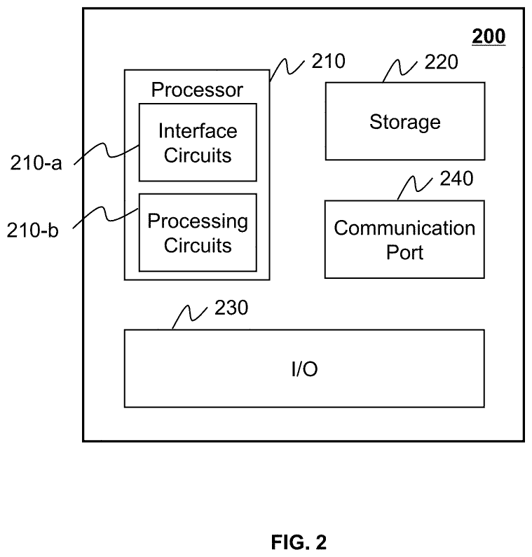

In some embodiments, the server 110 may be a single server or a server group. The server group may be centralized, or distributed (e.g., server 110 may be a distributed system). In some embodiments, the server 110 may be local or remote. For example, the server 110 may access information and/or data stored in the mobile terminal 140, and/or the storage device 150 via the network 120. As another example, the server 110 may be directly connected to the mobile terminal 140, and/or the storage device 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to vehicle value evaluation to perform one or more functions described in the present disclosure. For example, the processing engine 112 may determine a current estimated value of a target vehicle based on target information associated with the target vehicle. In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components in the vehicle value evaluation system 100 (e.g., the server 110, the mobile terminal 140, the storage device 150, and the positioning system 160) may send information and/or data to other component(s) in the vehicle value evaluation system 100 via the network 120. For example, the server 110 may send a current estimated value of a target vehicle to the mobile terminal 140 via the network 120. In some embodiments, the network 120 may be any type of wired or wireless network, or a combination thereof. Merely by way of example, the network 120 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the vehicle value evaluation system 100 may be connected to the network 120 to exchange data and/or information.

In some embodiments, the mobile terminal 140 may include a mobile device 140-1, a tablet computer 140-2, a laptop computer 140-3, or the like, or any combination thereof. In some embodiments, the mobile device 140-1 may include a smart home device, a wearable device, a mobile equipment, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile equipment may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc. In some embodiments, the mobile terminal 140 may be a device with positioning technology for locating the position of the mobile terminal 140. In some embodiments, the mobile terminal 140 may send positioning information to the server 110.

The storage device 150 may store data and/or instructions. In some embodiments, the storage device 150 may store data obtained from the mobile terminal 140. In some embodiments, the storage device 150 may store data and/or instructions that the server 110 may execute or use to perform exemplary methods described in the present disclosure. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components in the vehicle value evaluation system 100 (e.g., the server 110, the mobile terminal 140, etc.). One or more components in the vehicle value evaluation system 100 may access the data or instructions stored in the storage device 150 via the network 120. In some embodiments, the storage device 150 may be directly connected to or communicate with one or more components in the vehicle value evaluation system 100 (e.g., the server 110, the mobile terminal 140, etc.). In some embodiments, the storage device 150 may be part of the server 110.

The positioning system 160 may determine information associated with an object, for example, the mobile terminal 140. For example, the positioning system 160 may determine an accumulative mileage number of the mobile terminal 140 in real-time. In some embodiments, the positioning system 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, an accumulative mileage number, or a current time. The location may be in the form of coordinates, such as, latitude coordinate and longitude coordinate, etc. The positioning system 160 may include one or more satellites, for example, a satellite 160-1, a satellite 160-2, and a satellite 160-3. The satellites 160-1 through 160-3 may determine the information mentioned above independently or jointly. The satellite positioning system 160 may send the information mentioned above to the network 120, or the mobile terminal 140 via wireless connections.

FIG. 2 is a schematic diagram illustrating exemplary hardware and/or software components of an exemplary computing device 200 on which the processing engine 112 may be implemented according to some embodiments of the present disclosure. As illustrated in FIG. 2, the computing device 200 may include a processor 210, a storage 220, an input/output (I/O) 230, and a communication port 240.

The processor 210 (e.g., logic circuits) may execute computer instructions (e.g., program code) and perform functions of the processing engine 112 in accordance with techniques described herein. For example, the processor 210 may include interface circuits 210-a and processing circuits 210-b therein. The interface circuits may be configured to receive electronic signals from a bus (not shown in FIG. 2), wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus.

The computer instructions may include, for example, routines, programs, objects, components, data structures, procedures, modules, and functions, which perform particular functions described herein. For example, the processor 210 may process target information associated with a target vehicle obtained from the mobile terminal 140, the storage device 150, and/or any other component of the vehicle value evaluation system 100. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors, thus operations and/or method steps that are performed by one processor as described in the present disclosure may also be jointly or separately performed by the multiple processors. For example, if in the present disclosure the processor of the computing device 200 executes both step A and step B, it should be understood that step A and step B may also be performed by two or more different processors jointly or separately in the computing device 200 (e.g., a first processor executes step A and a second processor executes step B, or the first and second processors jointly execute steps A and B).

The storage 220 may store data/information obtained from the mobile terminal 140, the storage device 150, and/or any other component of the vehicle value evaluation system 100. In some embodiments, the storage 220 may include a mass storage, a removable storage, a volatile read-and-write memory, a read-only memory (ROM), or the like, or any combination thereof. For example, the mass storage may include a magnetic disk, an optical disk, a solid-state drives, etc. The removable storage may include a flash drive, a floppy disk, an optical disk, a memory card, a zip disk, a magnetic tape, etc. The volatile read-and-write memory may include a random access memory (RAM). The RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. The ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 220 may store one or more programs and/or instructions to perform exemplary methods described in the present disclosure. For example, the storage 220 may store a program for the processing engine 112 for determining a vehicle value.

The I/O 230 may input and/or output signals, data, information, etc. In some embodiments, the I/O 230 may enable a user interaction with the processing engine 112. In some embodiments, the I/O 230 may include an input device and an output device. Examples of the input device may include a keyboard, a mouse, a touch screen, a microphone, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touch screen, or the like, or a combination thereof.

The communication port 240 may be connected to a network (e.g., the network 120) to facilitate data communications. The communication port 240 may establish connections between the processing engine 112 and the mobile terminal 140, the positioning system 160, or the storage device 150. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee link, a mobile network link (e.g., 3G, 4G, 5G, etc.), or the like, or a combination thereof. In some embodiments, the communication port 240 may be and/or include a standardized communication port, such as RS232, RS485, etc.

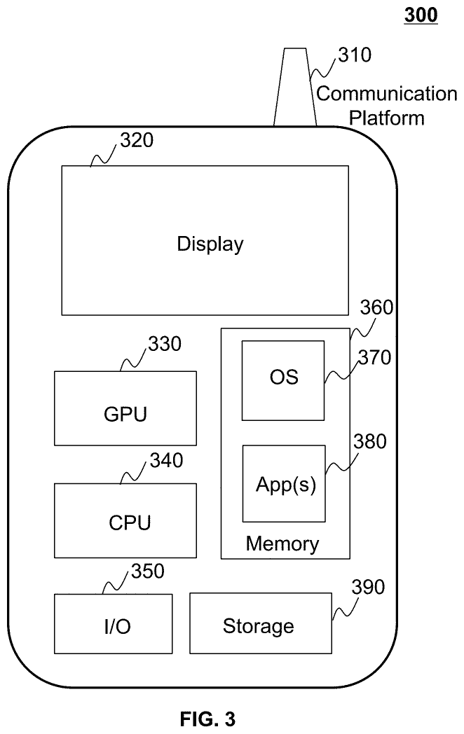

FIG. 3 is a schematic diagram illustrating exemplary hardware and/or software components of an exemplary mobile device 300 on which the mobile terminal 140 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the processing engine 112. User interactions with the information stream may be achieved via the I/O 350 and provided to the processing engine 112 and/or other components of the vehicle value evaluation system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

One of ordinary skill in the art would understand that when an element of the vehicle value evaluation system 100 performs, the element may perform through electrical signals and/or electromagnetic signals. For example, when the processing engine 112 processes a task, such as making a determination, or identifying information, the processing engine 112 may operate logic circuits in its processor to process such task. When the processing engine 112 sends out data (e.g., a current estimated value of a target vehicle) to the mobile terminal 140, a processor of the processing engine 112 may generate electrical signals encoding the data. The processor of the processing engine 112 may then send the electrical signals to an output port. If the mobile terminal 140 communicates with the processing engine 112 via a wired network, the output port may be physically connected to a cable, which may further transmit the electrical signals to an input port of the server 110. If the mobile terminal 140 communicates with the processing engine 112 via a wireless network, the output port of the processing engine 112 may be one or more antennas, which may convert the electrical signals to electromagnetic signals. Within an electronic device, such as the mobile terminal 140, and/or the server 110, when a processor thereof processes an instruction, sends out an instruction, and/or performs an action, the instruction and/or action is conducted via electrical signals. For example, when the processor retrieves or saves data from a storage medium (e.g., the storage device 150), it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

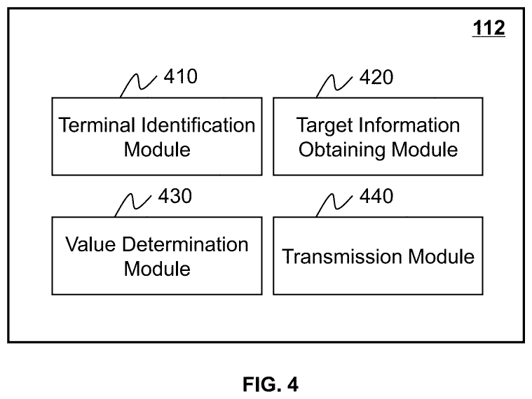

FIG. 4 is a schematic block diagram illustrating an exemplary processing engine 112 according to some embodiments of the present disclosure. The processing engine 112 may include a terminal identification module 410, a target information obtaining module 420, a value determination module 430, and a transmission module 440.

The terminal identification module 410 may be configured to identify a mobile terminal, such as identify an identity of the mobile terminal 140. In some embodiments, one or more mobile terminals may establish a communication (e.g., a wireless communication) with the processing engine 112, via an application installed in the one or more mobile terminals. The mobile terminal may be bonded to the vehicle through the application. The application may be configured to manage the vehicle for a user (e.g., an owner/driver of a private car, or a driver of a taxi or other type of vehicle) associated with the vehicle.

In some embodiments, the application may obtain and/or receive various information about the vehicle. For example, the information may include, but not limited to, a vehicle brand, a vehicle type, a license plate number, a vehicle identification number (VIN), a license plate attribution, mileage information, a production date, a register date, one or more pictures of the vehicle, driving history, accident history, and/or an estimated value of the vehicle, etc. The application may obtain the information from the server 110 or from user input, and may display the information through a display of the mobile terminal.

In some embodiments, the application may provide a power supply entry for gas filling and/or battery charging, and/or a maintenance entry for repair and/or maintenance. The user may pay the gas filling and/or the battery charging through the power supply entry. The user may pay the repair and/or the maintenance through the maintenance entry. The user may also make an appointment relating to the repair and/or the maintenance through the maintenance entry.

In some embodiments, the application may obtain vehicle news, such as hot topics, special offers, real-time road conditions, etc. from the server 110 and display the vehicle news through the display of the mobile terminal.

The user may register an account of the application and bond a vehicle to the account. The application may provide a user interface. The user may input, through the user interface, register information such as a name of the user, a cellphone number, an e-mail address, an identification of the user (e.g., an ID card number, a passport number, or a driving license number), a license plate number of the vehicle associated with the user, or a vehicle identification number (VIN) of the vehicle associated with the user to register an account of the application. The mobile terminal 140 may send the register information to the processing engine 112. After receiving the register information, the processing engine 112 may establish an account for the user and store the account in a storage medium (e.g., the storage device 150, or the storage 220 of the processing engine 112).

In some embodiments, the terminal identification module 410 may access the storage medium to identify the account of the application and identify a mobile terminal 140 that operates the account.

The target information obtaining module 420 may be configured to obtain target information associated with a target vehicle associated with the mobile terminal 140. The target information may also be associated with the mobile terminal 140. The target vehicle may refer to a vehicle tied to and/or bonded with the account of the application. The target information associated with the target vehicle may include a vehicle brand, a vehicle type, a license plate attribution, a production date, a register date, power supply information, maintenance information, mileage information, accident information, maintenance information, or the like, or any combination thereof.

In some embodiments, the user may input the target information through the user interface of the application. In some embodiments, the mobile terminal 140 may obtain the vehicle brand, the vehicle type, the license plate attribution, the production date, or the register date using, for example, an optical character recognition technology (OCR). For example, the mobile terminal 140 may scan a vehicle license of the target vehicle through a camera of the mobile terminal 140 to obtain the vehicle brand, the vehicle type, the license plate attribution, the production date, or the register date.

In some embodiments, a third party (e.g., a maintenance store, an insurance company, a transportation department, etc. that is affiliated with the platform/system 100) may collect the target information in and send the up-to-date target information to the processing engine 112. The processing engine 112 may store the target information in a storage medium (e.g., the storage device 150, or the storage 220 of the processing engine 112). The target information obtaining module 420 may access the storage medium to obtain the target information.

For example, when the user of the target vehicle sends the target vehicle to a gas station or a maintenance store affiliated with the system and/or platform 100 at 2:00 p.m. July 1, the gas station or the maintenance store may send the mileage information, gas filing information, accident information, maintenance information as well as other needed information of the vehicle to the sever 110. For example, a maintenance engineer in the maintenance store may read the mileage number from the odometer of the target vehicle and send the mileage number to the processing engine 112 through an electronic device communicating with the processing engine 112. Such information may be actual information of the target vehicle, but is only up-to-date at the moment of gas filing or maintenance. When the vehicle leaves the gas station or the maintenance store, however, the information becomes historical information.

In some embodiments, the processing engine 112 may collect the target information from the mobile terminal in real-time or substantial real-time. The processing engine 112 may store the target information in a storage medium (e.g., the storage device 150, or the storage 220 of the processing engine 112). The target information obtaining module 420 may access the storage medium to obtain the target information. For example, the processing engine 112 may collect an accumulative mileage number of the mobile terminal 140 (rather than an accumulative mileage number of the target vehicle) up to a substantial present moment and treat the accumulative mileage number of the mobile terminal 140 as that of the target vehicle's. In some embodiments, when moving relative to the ground, the mobile terminal 140 may determine a mileage number of the mobile terminal 140 in real-time using a positioning technology (e.g., GPS, or a speed sensor) in the mobile terminal 140. The application may direct the mobile terminal 140 to constantly transmit the mileage number of the mobile terminal 140 or the position of the mobile terminal 140 to the processing engine 112 in real-time. For example, when the user logs in the account associated with the target vehicle through the application, the application may determine that the mobile terminal 140 is moving and direct the mobile terminal 140 to constantly transmit the mileage number or location of the mobile terminal 140 to the processing engine 112 in real-time. The processing engine 112 may track the mobile terminal mileage by receiving the mileage number directly from the mobile terminal or through tracking the location of the mobile terminal 140. The processing engine 112 may track the mobile terminal mileage regardless of whether the mobile terminal 140 is moving with the target vehicle. Alternatively, the processing engine 112 may track the mobile terminal mileage only after determining that the mobile terminal 140 is moving together with the target vehicle. Tracking the mileage of the mobile terminal can be real-time or substantial real-time, but because the mobile terminal is an independent device not always attached to the target vehicle, the mileage of the mobile terminal may include a large error from the actual mileage of the vehicle.

Alternatively, the processing engine 112 may adopt a hybrid model to calibrate the mobile terminal mileage with the actual mileage of the target vehicle. To this end, the mileage information may include an actual accumulative mileage number of the target vehicle at a reference time point (e.g., a predetermined time point) and an accumulative mileage number of the mobile terminal 140 between the reference time point and a substantial present moment. For example, when the user of the target vehicle sends the target vehicle to a maintenance store affiliated with the system and/or platform 100 at 2:00 p.m. July 1, the maintenance store may read the actual mileage number of the target vehicle from its odometer and send the actual mileage information to the sever 110. The processing engine may update the mileage record of the target vehicle in the storage device 150, and may also update the mileage record stored in the application of the mobile terminal 140. This update calibrates the mileage information of the target vehicle in both the system 100 and the mobile terminal 140. After the update at 2:00 p.m. July 1 (i.e., the reference time point or the predetermined time point), the processing engine 112 may monitor and collect the mileage of the mobile terminal from 2:00 p.m. July 1 in real-time or substantially real-time through a GPS application installed in the mobile terminal. The processing engine 112 may add the mobile terminal mileage to the target vehicle mileage information at 2:00 p.m. July 1, and treat the summation of the two mileages as the real-time mileage of the target vehicle until the next update of the true mileage of the target vehicle occurs.

In some embodiments, the accumulative mileage number of the mobile terminal 140 may include a mileage number having no connection with the target vehicle, such as a walking mileage number of the user or a mileage number relating to vehicles other than the target vehicle. The application installed in the mobile terminal 140 may identify frequency patterns of walking and deduct the corresponding mileage from the overall mileage of the mobile terminal 140 when sending the mobile terminal mileage to the processing engine 112.

The processing engine 112 may obtain and update other target information in a similar fashion as the mileage information of the target vehicle.

In some embodiments, the maintenance information may include a maintenance item (e.g., oil changes, tune ups, replacement of belts and hoses, etc.), a breakdown of the target vehicle, a repair item (e.g., a major repair of engine, repainting, a repair of brakes, a repair of exhaust system, etc.), or the like, or any combination thereof. After a repair or maintenance to the target vehicle, the user of the mobile terminal 140 and/or a maintenance engineer may input the maintenance information through the application (e.g., the maintenance entry) and/or an electronic device communicating with the processing engine 112 in a maintenance store. Alternatively, because the user may pay the maintenance and/or the repair through the maintenance entry of the application, the mobile terminal 140 may obtain the maintenance information based on an electric bill of maintenance and/or repair in the maintenance entry. The mobile terminal 140 and/or the electronic device in the maintenance store may send the maintenance information to the processing engine 112.

In some embodiments, the power supply information may include a total times of power supply up to a substantial present moment, an amount of power supply each time, or the like, or any combination thereof. After a power supply, the user may input the power supply through the application (e.g., the power supply entry). Alternatively, because the user may pay the power supply through the power supply entry of the application, the mobile terminal 140 may obtain the power supply information based on an electric bill of power supply in the power supply entry. The mobile terminal 140 may send the power supply information to the processing engine 112.

In some embodiments, the accident information may include a cause of an accident, an occurrence time of an accident, damage information of the target vehicle, or the like, or any combination thereof. An insurance company of which the user buys a vehicle insurance for the target vehicle and/or a transportation department may send the accident information to the processing engine 112.

The value determination module 430 may be configured to determine a current estimated value of the target vehicle based on the target information. The current estimated value of the target vehicle may refer to an estimated fair market value (FMV) of the target vehicle relating to the present moment.

The transmission module 440 may be configured to send the current estimated value of the target vehicle to the mobile terminal 140.

The modules in the server 110 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units. For example, the terminal identification module 410 may be integrated in the vehicle identification module 420 as a single module which may both identify a mobile terminal and a target vehicle associated with the mobile terminal.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the processing engine 112 may further include a storage module (not shown in FIG. 4). The storage module may be configured to store data generated during any process performed by any component of in the processing engine 112. As another example, each of components of the processing engine 112 may correspond to a storage module, respectively. Additionally or alternatively, the components of the processing engine 112 may share a common storage module.

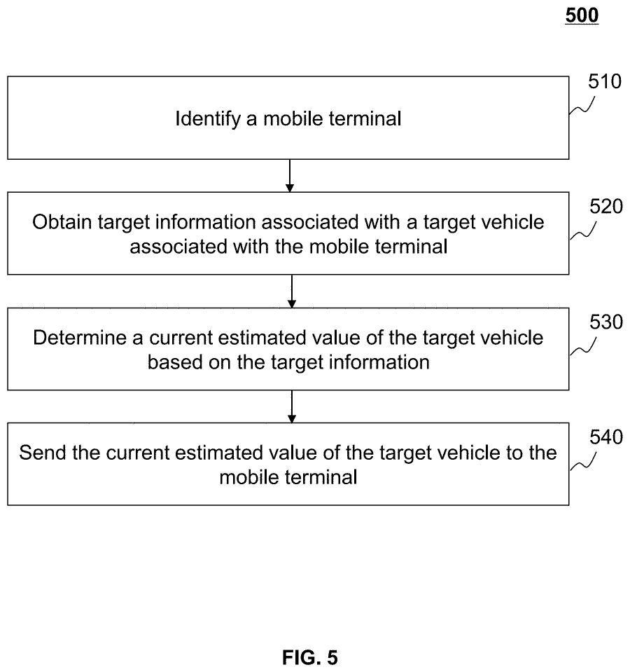

FIG. 5 is a flowchart illustrating an exemplary process 500 for determining a vehicle value according to some embodiments of the present disclosure. In some embodiments, the process 500 may be implemented in the vehicle value evaluation system 100 illustrated in FIG. 1. For example, the process 500 may be stored in a storage medium (e.g., the storage device 150, or the storage 220 of the processing engine 112) as a form of instructions, and invoked and/or executed by the server 110 (e.g., the processing engine 112 of the server 110, the processor 220 of the processing engine 112, or one or more modules in the processing engine 112 illustrated in FIG. 4). The operations of the illustrated process 500 presented below are intended to be illustrative. In some embodiments, the process 500 may be accomplished with one or more additional operations not described, and/or without one or more of the operations discussed. Additionally, the order in which the operations of the process 500 as illustrated in FIG. 5 and described below is not intended to be limiting.

In 510, the terminal identification module 410 (or the processing engine 112, or the interface circuits 210-a and the processing circuits 210-b) may identify the identity of a mobile terminal 140. For example, the interface circuits 210-a, may receive a communication message from the mobile terminal 140 and the processing circuits may extract the identity of the mobile terminal 140. In some embodiments, one or more mobile terminals may establish a communication (e.g., a wireless communication) with the processing engine 112, via an application installed in the one or more mobile terminals. A user associated with a vehicle (e.g., an owner of a private car, or a taxi driver) may register an account of the application and bond the vehicle to the account. The processing engine 112 may store the account in a storage medium (e.g., the storage device 150, or the storage 220 of the processing engine 112). The terminal identification module 410 may access the storage medium to identify the account of the application and identify a mobile terminal 140 that operates the account.

In 520, the target information obtaining module 420 (or the processing engine 112, or the processing circuits 210-b) may identify a target mobile associated with the identity of the mobile terminal and then obtain target information associated with the target vehicle associated with the mobile terminal.

In some embodiments, the mobile terminal 140 may be independent and not installed in the target vehicle. The mobile terminal 140 and/or a third party (e.g., a maintenance store, an insurance company, a transportation department, etc.) may collect the target information in real-time and send the up-to-date target information to the processing engine 112 in real-time. The processing engine 112 may store the target information in a storage medium (e.g., the storage device 150, or the storage 220 of the processing engine 112). The target information obtaining module 420 may access the storage medium to obtain the target information.

In 530, the value determination module 430 (or the processing engine 112, or the processing circuits 210-b) may determine a current estimated value of the target vehicle based on the target information.

In some embodiments, the target information of the target vehicle may have an impact on the current estimated value of the target vehicle. For example, major repairs to the target vehicle may reduce the current estimated value of target vehicle. As another example, maintenance (e.g., oil changes, tune ups, replacement of belts and hoses, etc.) performed at prescribed intervals may contribute positively in the determination of the current estimated value. As still another example, an increase of the accumulative mileage number of the mobile terminal 140 may reduce the current estimated value. As still another example, accidents occurring to the target vehicle may reduce the current estimated value.

In some embodiments, the value determination module 430 may determine the current estimated value of the target vehicle based on a machine leaning model such as a gradient boosting decision tree (GBDT) model, a deep learning (DL) model, etc.

In 540, the transmission module 440 (or the processing engine 112, or the interface circuits 210-a) may send the current estimated value of the target vehicle of the mobile terminal 140. In some embodiments, the transmission module 440 may compare the current estimated value with a last estimated value of the target vehicle. For example, the current time is Jun. 14, 2017, and the processing engine 112 determined three estimated values of the target vehicle at Apr. 1, 2017, May 1, 2017, and Jun. 1, 2017. The transmission module 440 may compare the current estimated value with the estimated value of the target vehicle determined at Jun. 1, 2017. The transmission module 440 may determine whether the current estimated value is different from the last estimated value. The transmission module 440 may send the current estimated value of the target vehicle of the mobile terminal 140 in response to a determination that the current estimated value is different from the last estimated value. In some embodiments, when receiving the current estimated value of the target vehicle, the mobile terminal 140 may display the current estimated value in the user interface of the application. In some embodiments, the transmission module 440 may send a reminder indicating whether the current estimated value is different from the last estimated value to the mobile terminal 140. Further, the transmission module 440 may send a reminder indicating that the current estimated value is different from the last estimated value to the mobile terminal 140. The reminder may be in a form of text, picture, video, voice, or the like, or any combination thereof.

In some embodiments, the processing engine 112 may update the estimated value of the target vehicle at intervals by performing the process 500 repeatedly. The process 500 may be triggered by a predetermined condition that occurs to the target vehicle.

In some embodiments, the processing engine 112 may perform the process 500 upon a request sent from the mobile terminal 140. The user of the mobile terminal 140 may press a button in the application so that the mobile terminal 140 may send a request of evaluating the target vehicle to the processing engine 112.

In some embodiments, the processing engine 112 may perform the process 500 automatically and/or without receiving a request from the target vehicle or from the mobile terminal 140.

In some embodiments, the processing engine 112 may perform the process 500 periodically. The processing engine 112 may compare the current time with the last time of vehicle value evaluation. When the processing engine 112 determines that the time interval between the current time and the last time of vehicle value evaluation is equal to a predetermined time interval (e.g., 1 month), the processing engine 112 may perform the process 500.

In some embodiments, the processing engine 112 may perform the process 500 when a predetermined event occurs to the target vehicle. The processing engine 112 may receive up-to-date target information associated with the target vehicle in real-time so that the processing engine 112 may monitor the target vehicle based on the up-to-date target information and determine whether a predetermined event occurs to the target vehicle based on the up-to-date target information. The predetermined event may refer to an event that may affect the current estimated value of the target vehicle.

In some embodiments, a repair to the target vehicle may reduce the current estimated value of the target vehicle. The processing engine 112 may perform the process 500 when a repair is performed to the target vehicle or when the accumulative number of repairs to the target vehicle satisfies a first predetermined condition. For example, the first predetermined condition may be a condition of a multiple of five. The processing engine 112 may perform the process 500 when the accumulative number of repairs to the target vehicle is equal to a multiple of five such as 5, 10, 15, 20, etc.

In some embodiments, maintenance (e.g., oil changes, tune ups, replacement of belts and hoses, etc.) to the target vehicle may contribute positively in the determination of the current estimated value. The processing engine 112 may perform the process 500 when maintenance is performed to the target vehicle or when the accumulative number of times of performing maintenance to the target vehicle satisfies a second predetermined condition. For example, the second predetermined condition may be a condition of a multiple of five. The processing engine 112 may perform the process 500 when the accumulative number of times of performing maintenance to the target vehicle is equal to a multiple of five such as 5, 10, 15, 20, etc.

In some embodiments, an increase of the accumulative mileage number may reduce the current estimated value of the target vehicle. The processing engine 112 may perform the process 500 when the processing engine 112 receives a modified accumulative mileage number or when the accumulative mileage number of the mobile terminal 140 satisfies a third predetermined condition. For example, the third predetermined condition may be a condition of a multiple of 1000 kilometers. The processing engine 112 may perform the process 500 when the accumulative mileage number of the mobile terminal 140 is equal to a multiple of 1000 kilometers such as 1000 kilometers, 2000 kilometers, 3000 kilometers, 4000 kilometers, etc.

In some embodiments, a power supply (e.g., gas filling, or battery charging) may reduce the current estimated value of the target vehicle because the power supply indirectly reflects an increase of the accumulative mileage number. The processing engine 112 may perform the process 500 when a power supply is performed to the target vehicle or when the accumulative number of power supplies to the target vehicle satisfies a fourth predetermined condition. For example, the fourth predetermined condition may be a condition of a multiple of ten. The processing engine 112 may perform the process 500 when the accumulative number of power supplies to the target vehicle is equal to a multiple of ten such as 10, 20, 30, 40, etc.

In some embodiments, an accident to the target vehicle may reduce the current estimated value of the target vehicle. The processing engine 112 may perform the process 500 when an accident occurs to the target vehicle or when the accumulative number of accidents occurring to the target vehicle satisfies a fifth predetermined condition. For example, the fifth predetermined condition may be a condition of a multiple of three. The processing engine 112 may perform the process 500 when the accumulative number of accidents occurring to the target vehicle is equal to a multiple of three such as 3, 6, 9, 12, etc.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. An electronic system for determining a vehicle value, comprising:
one or more storage media comprising a set of instructions; and
one or more processors configured to communicate with the one or more storage media, wherein when executing the set of instructions, the one or more processors are directed to:
identify a mobile terminal;
obtain target information associated with the mobile terminal and a target vehicle associated with the mobile terminal;
determine a current estimated value of the target vehicle based on the target information; and
send the current estimated value of the target vehicle to the mobile terminal.

2. The electronic system of claim 1, wherein the target information includes an accumulative mileage number up to a substantial present moment of the mobile terminal.

3. The electronic system of claim 1, wherein the target information includes an accumulative mileage number of the mobile terminal between a predetermined time point and a substantial present moment, and an accumulative mileage number of the target vehicle up to the predetermined time point.

4. The electronic system of claim 1, wherein the one or more processors are further directed to:
determine whether the current estimated value is different from a last estimated value; and
determine that the current estimated value is different from the last estimated value.

5. The electronic system of claim 4, wherein the one or more processors are further directed to:
send, to the mobile terminal, a reminder indicating whether the current estimated value is different from the last estimated value.

6. The electronic system of claim 1, wherein the one or more processors are further directed to:
determine that a predetermined condition occurs to the target vehicle.

7. The electronic system of claim 6, wherein the predetermined condition includes a condition that an interval between a substantial present moment and a last time of vehicle value evaluation is equal to a predetermined time interval.

8. The electronic system of claim 6, wherein the predetermined condition includes a condition that a predetermined event that affects the current estimated value occurs to the target vehicle.

9. A method for determining a vehicle value implemented on a machine having at least one processor and at least one storage device, comprising:
identifying, by the at least one processor, a mobile terminal;
obtaining, by the at least one processor, target information associated with the mobile terminal and a target vehicle associated with the mobile terminal;
determining, by the at least one processor, a current estimated value of the target vehicle based on the target information; and
sending, by the at least one processor, the current estimated value of the target vehicle to the mobile terminal.

10. The method of claim 9, wherein the target information includes an accumulative mileage number up to a substantial present moment of the mobile terminal.

11. The method of claim 9, wherein the target information includes an accumulative mileage number of the mobile terminal between a predetermined time point and a substantial present moment, and an accumulative mileage number of the target vehicle up to the predetermined time point.

12. The method of claim 9, further comprising:
determining, by the at least one processor, whether the current estimated value is different from a last estimated value; and
determining, by the at least one processor, that the current estimated value is different from the last estimated value.

13. The method of claim 12, further comprising:
sending, by the at least one processor to the mobile terminal, a reminder indicating whether the current estimated value is different from the last estimated value.

14. The method of claim 9, further comprising:
determining, by the at least one processor, that a predetermined condition occurs to the target vehicle.

15. The method of claim 14, wherein the predetermined condition includes a condition that an interval between a substantial present moment and a last time of vehicle value evaluation is equal to a predetermined time interval.

16. The method of claim 14, wherein the predetermined condition includes a condition that a predetermined event that affects the current estimated value occurs to the target vehicle.

17. A non-transitory processor-readable storage medium, comprising a set of instructions for determining value of a vehicle, wherein when executed by at least one processor, the set of instruction directs the at least one processor to perform acts of:
identifying a mobile terminal;
obtaining target information associated with the mobile terminal and a target vehicle associated with the mobile terminal;
determining a current estimated value of the target vehicle based on the target information; and
sending the current estimated value of the target vehicle to the mobile terminal.

18. The storage medium of claim 17, wherein the target information includes an accumulative mileage number up to a substantial present moment of the mobile terminal.

19. The storage medium of claim 17, wherein the target information includes an accumulative mileage number of the mobile terminal between a predetermined time point and a substantial present moment, and an accumulative mileage number of the target vehicle up to the predetermined time point.

20. The storage medium of claim 17, wherein the at least one processor is further directed to:
determining that a predetermined condition occurs to the target vehicle,
wherein the predetermined condition includes at least one of
a condition that an interval between a substantial present moment and a last time of vehicle value evaluation is equal to a predetermined time interval, or
a condition that a predetermined event that affects the current estimated value occurs to the target vehicle.
